(19) United States
(12) Patent Application Publication
(10) Pub. No.: US 2023/0384420 A1
(43) Pub. Date: Nov. 30, 2023

(54) APPARATUS AND METHOD FOR POWER SAVING IN GESTURE RECOGNITION USING MMWAVE RADAR

(71) Applicant: Samsung Electronics Co., Ltd., Suwon-si (KR)

(72) Inventors: Priyabrata Parida, Garland, TX (US); Vutha Va, Plano, TX (US); Anum Ali, Plano, TX (US)

(21) Appl. No.: 18/068,513

(22) Filed: Dec. 19, 2022

Related U.S. Application Data
(60) Provisional application No. 63/347,390, filed on May 31, 2022.

(51) Int. Cl. G01S 7/41; G01S 13/56

(52) U.S. Cl. CPC G01S 7/415; G01S 7/417; G01S 13/56

(57) ABSTRACT

A method includes, during operation of a proximity-detection module of an electronic device: determining a distance, velocity, and angle of a target relative to the electronic device based on radar data obtained from a radar transceiver of the electronic device; adjusting a configuration of the radar transceiver based on at least one of the distance, velocity, or angle of the target; and while at least one of the distance, velocity, or angle is greater than a respective threshold, repeating the determining and adjusting operations. The method also includes, in response to determining that each of the distance, velocity, and angle is less than its respective threshold, determining whether at least one wake-up trigger for gesture-based commands is detected. The method further includes, in response to determining that the at least one wake-up trigger for gesture-based commands is detected, triggering operation of a gesture-recognition module of the electronic device.

### CROSS-REFERENCE TO RELATED APPLICATIONS AND CLAIM OF PRIORITY

The present application claims priority to U.S. Provisional Patent Application No. 63/347,390 filed on May 31, 2022. The content of the above-identified patent document is incorporated herein by reference.

### TECHNICAL FIELD

The present disclosure relates generally to wireless communication systems and, more specifically, the present disclosure relates to an apparatus and method for power saving in gesture recognition using millimeter wave (mmWave) radar.

### BACKGROUND

The superior spatial and Doppler resolution of mmWave radars have opened up new horizons for human-computer interaction (HCI), where smart devices, such as a smart phone, can be controlled through micro-gestures. While gesture-based commands represent one type of application of the mmWave radars, the range detection capabilities of the radar can also be used to sense the presence of a human in the radar proximity. This information can be used in various ways, such as maximum permissible exposure management, device wake-up for initiating security identification, and the like.

### SUMMARY

The present disclosure relates to wireless sensing systems and, more specifically, the present disclosure relates to a system and method for power saving in gesture recognition using mmWave radar.

In one embodiment, a method includes, during operation of a proximity-detection module of an electronic device: determining a distance, velocity, and angle of a target relative to the electronic device based on radar data obtained from a radar transceiver of the electronic device; adjusting a configuration of the radar transceiver based on at least one of the distance, velocity, or angle of the target; and while at least one of the distance, velocity, or angle is greater than a respective threshold, repeating the determining and adjusting operations. The method also includes, in response to determining that each of the distance, velocity, and angle is less than its respective threshold, determining whether at least one wake-up trigger for gesture-based commands is detected. The method further includes, in response to determining that the at least one wake-up trigger for gesture-based commands is detected, triggering operation of a gesture-recognition module of the electronic device.

In another embodiment, a device includes a radar transceiver and a processor operably connected to the radar transceiver. The processor is configured to, during operation of a proximity-detection module: determine a distance, velocity, and angle of a target relative to the device based on radar data obtained from the radar transceiver; adjust a configuration of the radar transceiver based on at least one of the distance, velocity, or angle of the target; and, while at least one of the distance, velocity, or angle is greater than a respective threshold, repeat the determine and adjust operations. The processor is also configured to, in response to determining that each of the distance, velocity, and angle is less than its respective threshold, determine whether at least one wake-up trigger for gesture-based commands is detected. The processor is further configured to, in response to determining that the at least one wake-up trigger for gesture-based commands is detected, trigger operation of a gesture-recognition module.

In yet another embodiment, a non-transitory computer readable medium includes program code that, when executed by a processor of a device, causes the device to, during operation of a proximity-detection module: determine a distance, velocity, and angle of a target relative to the device based on radar data obtained from a radar transceiver of the device; adjust a configuration of the radar transceiver based on at least one of the distance, velocity, or angle of the target; and while at least one of the distance, velocity, or angle is greater than a respective threshold, repeating the determine and adjust operations. The program code also causes the device to, in response to determining that each of the distance, velocity, and angle is less than its respective threshold, determine whether at least one wake-up trigger for gesture-based commands is detected. The program code further causes the device to, in response to determining that the at least one wake-up trigger for gesture-based commands is detected, trigger operation of a gesture-recognition module of the device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication and/or sensing. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system according to embodiments of the present disclosure;

FIG. 2 illustrates an example electronic device according to embodiments of the present disclosure;

FIG. 3 shows an example high level architecture of common monostatic radar according to embodiments of the present disclosure;

FIG. 4 illustrates an example process for switching from a proximity-sensing mode to a gesture-recognition mode according to embodiments of the present disclosure;

FIGS. 5A and 5B illustrate examples of a typical range-Doppler map and a typical range-azimuth (angle) map;

FIG. 6 illustrates a process performed by a proximity detection module while executing in a UE according to embodiments of the present disclosure;

FIG. 7 illustrates a process performed by a UE for application driven triggering of a gesture-recognition module (GRM), according to embodiments of the present disclosure;

FIG. 8 illustrates a process for triggering the GRM based on detection of a repetitive micro-gesture as a wake-up gesture, according to embodiments of the present disclosure;

FIG. 9 illustrates charts showing a variation in the normalized distance and azimuth angle of a target (e.g., a finger) for the repetitive micro-gesture;

FIG. 10 illustrates charts showing the corresponding Fourier spectrums of the estimated distance and azimuth angle of the finger for the data presented in FIG. 9;

FIG. 11 illustrates an example process for triggering the GRM based on detection of a palm facing the radar as a wake-up gesture, according to embodiments of the present disclosure;

FIG. 12 illustrates an example process for triggering the GRM based on detection of a micro-movement of multiple fingers as a wake-up gesture, according to embodiments of the present disclosure; and

FIG. 13 illustrates an example process for triggering the GRM using a voice-assisted wake-up trigger according to embodiments of the present disclosure.

### DETAILED DESCRIPTION

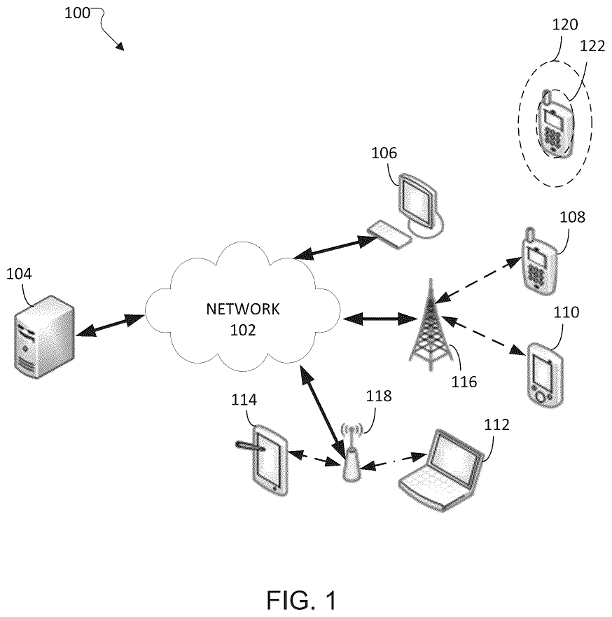

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example communication system 100 according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone, a tablet computer, a laptop, a personal computer, a wearable device, a head mounted display, or the like. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102.

Each of the client devices 106-114 represent any suitable computing or processing device that interacts with at least one server (such as the server 104) or other computing device(s) over the network 102. The client devices 106-114 include a desktop computer 106, a mobile telephone or mobile device 108 (such as a smartphone), a PDA 110, a laptop computer 112, and a tablet computer 114. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. In certain embodiments, any of the client devices 106-114 can emit and collect radar signals via a radar transceiver. In certain embodiments, the client devices 106-114 are able to sense the presence of an object located close to the client device and determine whether the location of the detected object is within a first area 120 or a second area 122 closer to the client device than a remainder of the first area 120 that is external to the first area 120. In certain embodiments, the boundary of the second area 122 is at a predefined proximity (e.g., 20 centimeters away) that is closer to the client device than the boundary of the first area 120, and the first area 120 can be a within a predefined range (e.g., 1 meter away, 2 meters away, or 5 meters away) from the client device where the user is likely to perform a gesture.

In this example, some client devices 108 and 110-114 communicate indirectly with the network 102. For example, the mobile device 108 and PDA 110 communicate via one or more base stations 116, such as cellular base stations or eNodeBs (eNBs) or gNodeBs (gNBs). Also, the laptop computer 112 and the tablet computer 114 communicate via one or more wireless access points 118, such as IEEE 802.11 wireless access points. Note that these are for illustration only and that each of the client devices 106-114 could communicate directly with the network 102 or indirectly with the network 102 via any suitable intermediate device(s) or network(s). In certain embodiments, any of the client devices 106-114 transmit information securely and efficiently to another device, such as, for example, the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

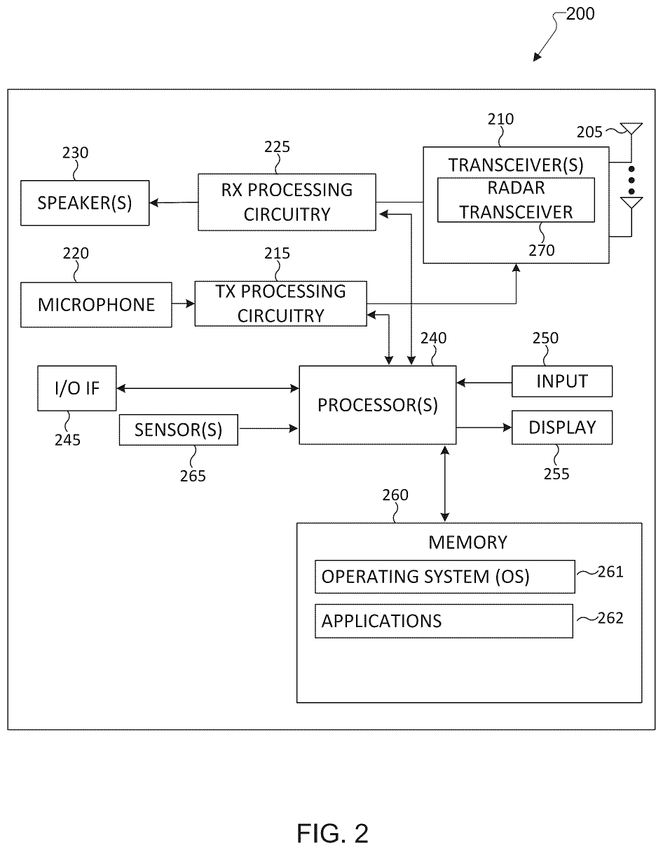

FIG. 2 illustrates an example electronic device 200 according to embodiments of the present disclosure. The electronic device 200 could represent the server 104 or one or more of the client devices 106-114 in FIG. 1. The electronic device 200 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, or the tablet computer 114 of FIG. 1), a robot, and the like. However, electronic devices come in a wide variety of configurations, and FIG. 2 does not limit the scope of this disclosure to any particular implementation of electronic device.

As shown in FIG. 2, the electronic device 200 includes transceiver(s) 210, transmit (TX) processing circuitry 215, a microphone 220, and receive (RX) processing circuitry 225. The transceiver(s) 210 can include, for example, a RF transceiver, a BLUETOOTH transceiver, a WiFi transceiver, a ZIGBEE transceiver, an infrared transceiver, and various other wireless communication signals. The electronic device 200 also includes a speaker 230, a processor 240, an input/output (I/O) interface (IF) 245, an input 250, a display 255, a memory 260, and a sensor 265. The memory 260 includes an operating system (OS) 261, and one or more applications 262.

The transceiver(s) 210 can include an antenna array 205 including numerous antennas. The antennas of the antenna array can include a radiating element composed of a conductive material or a conductive pattern formed in or on a substrate. The transceiver(s) 210 transmit and receive a signal or power to or from the electronic device 200. The transceiver(s) 210 receives an incoming signal transmitted from an access point (such as a base station, WiFi router, or BLUETOOTH device) or other device of the network 102 (such as a WiFi, BLUETOOTH, cellular, 5G, 6G, LTE, LTE-A, WiMAX, or any other type of wireless network). The transceiver(s) 210 down-converts the incoming RF signal to generate an intermediate frequency or baseband signal. The intermediate frequency or baseband signal is sent to the RX processing circuitry 225 that generates a processed baseband signal by filtering, decoding, and/or digitizing the baseband or intermediate frequency signal. The RX processing circuitry 225 transmits the processed baseband signal to the speaker 230 (such as for voice data) or to the processor 240 for further processing (such as for web browsing data).

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, and/or digitizes the outgoing baseband data to generate a processed baseband or intermediate frequency signal. The transceiver(s) 210 receives the outgoing processed baseband or intermediate frequency signal from the TX processing circuitry 215 and up-converts the baseband or intermediate frequency signal to a signal that is transmitted.

The processor 240 can include one or more processors or other processing devices. The processor 240 can execute instructions that are stored in the memory 260, such as the OS 261 in order to control the overall operation of the electronic device 200. For example, the processor 240 could control the reception of downlink (DL) channel signals and the transmission of uplink (UL) channel signals by the transceiver(s) 210, the RX processing circuitry 225, and the TX processing circuitry 215 in accordance with well-known principles. The processor 240 can include any suitable number(s) and type(s) of processors or other devices in any suitable arrangement. For example, in certain embodiments, the processor 240 includes at least one microprocessor or microcontroller. Example types of processor 240 include microprocessors, microcontrollers, digital signal processors, field programmable gate arrays, application specific integrated circuits, and discrete circuitry. In certain embodiments, the processor 240 can include a neural network.

The processor 240 is also capable of executing other processes and programs resident in the memory 260, such as operations that receive and store data. The processor 240 can move data into or out of the memory 260 as required by an executing process. In certain embodiments, the processor 240 is configured to execute the one or more applications 262 based on the OS 261 or in response to signals received from external source(s) or an operator. Example, applications 262 can include a multimedia player (such as a music player or a video player), a phone calling application, a virtual personal assistant, and the like.

The processor 240 is also coupled to the I/O interface 245 that provides the electronic device 200 with the ability to connect to other devices, such as client devices 106-114. The I/O interface 245 is the communication path between these accessories and the processor 240.

The processor 240 is also coupled to the input 250 and the display 255. The operator of the electronic device 200 can use the input 250 to enter data or inputs into the electronic device 200. The input 250 can be a keyboard, touchscreen, mouse, track ball, voice input, or other device capable of acting as a user interface to allow a user in interact with the electronic device 200. For example, the input 250 can include voice recognition processing, thereby allowing a user to input a voice command. In another example, the input 250 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 250 can be associated with the sensor(s) 265, a camera, and the like, which provide additional inputs to the processor 240. The input 250 can also include a control circuit. In the capacitive scheme, the input 250 can recognize touch or proximity.

The display 255 can be a liquid crystal display (LCD), light-emitting diode (LED) display, organic LED (OLED), active-matrix OLED (AMOLED), or other display capable of rendering text and/or graphics, such as from websites, videos, games, images, and the like. The display 255 can be a singular display screen or multiple display screens capable of creating a stereoscopic display. In certain embodiments, the display 255 is a heads-up display (HUD).

The memory 260 is coupled to the processor 240. Part of the memory 260 could include a RAM, and another part of the memory 260 could include a Flash memory or other ROM. The memory 260 can include persistent storage (not shown) that represents any structure(s) capable of storing and facilitating retrieval of information (such as data, program code, and/or other suitable information). The memory 260 can contain one or more components or devices supporting longer-term storage of data, such as a read only memory, hard drive, Flash memory, or optical disc.

The electronic device 200 further includes one or more sensors 265 that can meter a physical quantity or detect an activation state of the electronic device 200 and convert metered or detected information into an electrical signal. For example, the sensor 265 can include one or more buttons for touch input, a camera, a gesture sensor, optical sensors, cameras, one or more inertial measurement units (IMUs), such as a gyroscope or gyro sensor, and an accelerometer. The sensor 265 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 265 can further include control circuits for controlling any of the sensors included therein. Any of these sensor(s) 265 may be located within the electronic device 200 or within a secondary device operably connected to the electronic device 200.

The electronic device 200 as used herein can include a transceiver that can both transmit and receive radar signals. For example, the transceiver(s) 210 includes a radar transceiver 270, as described more particularly below. In this embodiment, one or more transceivers in the transceiver(s) 210 is a radar transceiver 270 that is configured to transmit and receive signals for detecting and ranging purposes. For example, the radar transceiver 270 may be any type of transceiver including, but not limited to a WiFi transceiver, for example, an 802.11ay transceiver. The radar transceiver 270 can operate both radar and communication signals concurrently. The radar transceiver 270 includes one or more antenna arrays, or antenna pairs, that each includes a transmitter (or transmitter antenna) and a receiver (or receiver antenna). The radar transceiver 270 can transmit signals at a various frequencies. For example, the radar transceiver 270 can transmit signals at frequencies including, but not limited to, 6 GHz, 7 GHz, 8 GHz, 28 GHz, 39 GHz, 60 GHz, and 77 GHz. In some embodiments, the signals transmitted by the radar transceiver 270 can include, but are not limited to, millimeter wave (mmWave) signals. The radar transceiver 270 can receive the signals, which were originally transmitted from the radar transceiver 270, after the signals have bounced or reflected off of target objects in the surrounding environment of the electronic device 200. In some embodiments, the radar transceiver 270 can be associated with the input 250 to provide additional inputs to the processor 240.

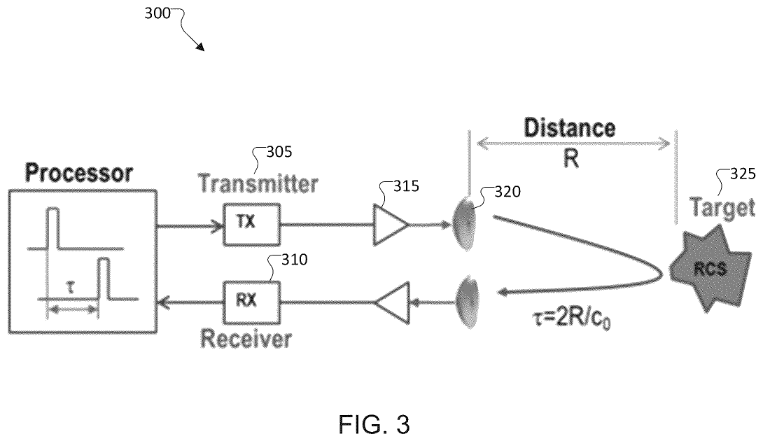

In certain embodiments, the radar transceiver 270 is a monostatic radar. A monostatic radar includes a transmitter of a radar signal and a receiver, which receives a delayed echo of the radar signal, which are positioned at the same or similar location. For example, the transmitter and the receiver can use the same antenna or nearly co-located while using separate, but adjacent antennas. Monostatic radars are assumed coherent such that the transmitter and receiver are synchronized via a common time reference. FIG. 3, below, illustrates an example monostatic radar.

In certain embodiments, the radar transceiver 270 can include a transmitter and a receiver. In the radar transceiver 270, the transmitter of can transmit millimeter wave (mmWave) signals. In the radar transceiver 270, the receiver can receive the mmWave signals originally transmitted from the transmitter after the mmWave signals have bounced or reflected off of target objects in the surrounding environment of the electronic device 200. The processor 240 can analyze the time difference between when the mmWave signals are transmitted and received to measure the distance of the target objects from the electronic device 200.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more neural networks, and the like. Also, while FIG. 2 illustrates the electronic device 200 configured as a mobile telephone, tablet, or smartphone, the electronic device 200 can be configured to operate as other types of mobile or stationary devices.

A common type of radar is the “monostatic” radar, characterized by the fact that the transmitter of the radar signal and the receiver for its delayed echo are, for all practical purposes, in the same location. FIG. 3 shows a high level architecture of an example common monostatic radar system 300, i.e., the transmitter 305 and receiver 310 are co-located, either by using a common antenna, or are nearly co-located, while using separate, but adjacent antennas. Monostatic radars are assumed coherent, i.e., the transmitter 305 and receiver 310 are synchronized via a common time reference.

In its most basic form, a radar pulse is generated as a realization of a desired “radar waveform,” modulated onto a radio carrier frequency and transmitted through a power amplifier 315 and antenna 320 (such as a parabolic antenna), either omni-directionally or focused into a particular direction. Assuming a “target” 325 at a distance R from the radar location and within the field-of-view of the transmitted signal, the target 325 will be illuminated by RF power density pₜ (e.g., in units of W/m²) for the duration of the transmission. To first order, pₜ can be described as:

$${p}_{t} = \frac{{P}_{T}}{4 π {R}^{2}} {G}_{T} = \frac{{P}_{T}}{4 π {R}^{2}} \frac{{A}_{T}}{( {λ}^{2} / 4 π )} = {P}_{T} \frac{{A}_{T}}{{λ}^{2} {R}^{2}} ,$$

where P_{T} is the transmit power[W]; G_{T}, A_{T} are the transmit antenna gain [dBi] and the effective aperture area [m²]; λ is the wavelength of the radar signal RF carrier signal [m]; and R is the target distance [m]. In this equation, the effects of atmospheric attenuation, multi-path propagation, antenna losses, etc., have been neglected.

The transmit power density impinging onto the target surface will lead to reflections depending on the material composition, surface shape, and dielectric behavior at the frequency of the radar signal. Note that off-direction scattered signals are typically too weak to be received back at the radar receiver 310, so only direct reflections will contribute to a detectable receive signal. In essence, the illuminated area(s) of the target 325 with normal vectors pointing back at the receiver 310 will act as transmit antenna apertures with directivities (gains) in accordance with their effective aperture area(s). The reflected-back power can be described as:

$${P}_{refl} = {p}_{t} {A}_{t} {G}_{t} ∼ {p}_{t} {A}_{t} {r}_{t} \frac{{A}_{t}}{( {λ}^{2} / 4 π )} = {p}_{t} R C S ,$$

where P_{refl} is the effective (isotropic) target-reflected power [W]; Aₜ, rₜ, Gₜ are the effective target area normal to the radar direction [m²], reflectivity of the material and shape [0, . . . 1], and corresponding aperture gain [dBi]; and RCS is the radar cross section [m²].

Note that the radar cross section, RCS, is an equivalent area that scales proportional to the actual reflecting area-squared, inversely proportional with the wavelength-squared, and is reduced by various shape factors and the reflectivity of the material itself. For a flat, fully reflecting minor of area Aₜ, large compared with λ², RCS=4πAₜ²/λ². Due to the material and shape dependency, it is generally not possible to deduce the actual physical area of a target 325 from the reflected power, even if the target distance is known (hence the existence of stealth objects that choose material absorption and shape characteristics carefully for minimum RCS).

The target-reflected power at the receiver location results from the reflected-power density at the reverse distance R, collected over the receiver antenna aperture area:

$${P}_{R} = \frac{{P}_{refl}}{4 π {R}^{2}} {A}_{R} = {P}_{T} \cdot R C S \frac{{A}_{T} {A}_{R}}{4 π {λ}^{2} {R}^{4}} ,$$

where P_{R} is the received, target-reflected power [W], and A_{R} is the receiver antenna effective aperture area [m²] (which may be same as A_{T}).

The radar system 300 is usable as long as the receiver signal exhibits sufficient signal-to-noise ratio (SNR), the particular value of which depends on the waveform and detection method used. Generally, in its simplest form:

$$S N R = \frac{{P}_{R}}{kT \cdot B \cdot F} ,$$

where kT is Boltzmann's constant x temperature [W/Hz], B is the radar signal bandwidth [Hz], and F is the receiver noise factor (degradation of receive signal SNR due to noise contributions of the receiver circuit itself).

In case the radar signal is a short pulse of duration (width) T_{P}, it will be apparent that the delay τ between the transmission and reception of the corresponding echo will be equal to τ=2R/c, where c is the speed of light propagation in the medium (air). In case there are several targets at slightly different distances, it will be equally apparent that the individual echos can be distinguished as such only if the delays differ by at least one pulse width, and hence the range resolution of the radar will be ΔR=cΔτ/2=cT_{P}/2. Further considering that a rectangular pulse of duration T_{P} exhibits a power spectral density P(ƒ)˜(sin (πƒT_{P})/(πƒT_{P}))² with the first null at its bandwidth B=1/T_{P}, the range resolution of a radar is fundamentally connected with the bandwidth of the radar waveform via ΔR=c/2B.

As discussed above, the superior spatial and Doppler resolution of mmWave radars have opened up new horizons for human-computer interaction (HCI), where smart devices, such as a smart phone, can be controlled through micro-gestures. While gesture-based commands represent one type of application of the mmWave radars, the range detection capabilities of the radar can also be used to sense the presence of a human in the radar proximity. This information can be used in various ways, such as maximum permissible exposure management, device wake-up for initiating security identification, and the like.

In some smart devices, the gesture-based control of the device is enabled by a gesture recognition module (GRM), which includes multiple functional blocks that leverage various machine learning-based models for accurate classification of the gesture performed by the user. Since these functional blocks are complex neural networks, they often require significant computational resources that adversely affect the battery life of the device. Further, for accurate classification of the micro-gestures, fine movements of the muscle groups in the fingers or fist of the user need to be captured by the radar. To meet this goal, the radar parameters are usually set to the highest possible configurations, which require more transmission power as well as circuit power.

In contrast, in a proximity-sensing mode, the target location can be detected reliably using simpler signal processing blocks compared to the complex machine learning blocks of the GRM. Further, the radar parameters can be set to lower configurations compared to the gesture-recognition mode, since capturing the fine movements of fingers is not necessary.

Since proximity-sensing mode consumes less power, unless there is a user in the proximity, it is better to keep the device running in the proximity-sensing mode. As the user approaches the device, the radar may be set to progressively higher configurations. Further, a user's mere presence near the device does not necessarily mean that the user wants to give gesture-based commands. Hence, triggering the GRM, which performs many complex operations for gesture recognition, simply in presence of the user is also not desirable.

To address these and other issues, this disclosure provides systems and methods for power saving in gesture recognition using mmWave radar. The disclosed embodiments efficiently switch from the proximity-sensing mode to the gesture-recognition mode without degrading the user experience. As described in more detail below, the disclosed embodiments include a three-step sequence including (i) accurate detection of the target in the radar proximity, (ii) determination of the status of the device to determine if it is ready to accept gesture-based inputs, and (iii) identification of a wake-up trigger, which can be gesture or voice-based. Once the device identifies the wake-up trigger, the GRM is enabled. By maintaining the proximity-sensing mode and then enabling GRM at a later time, operational power can be saved.

Note that some of the embodiments discussed below are described in the context of portable consumer electronic devices (e.g., smart phones) performing various use cases, including maximum permissible exposure (MPE) management, proximity sensing, gesture detection, liveness detection, sleep monitoring, and vital sign monitoring. However, these are merely examples. It will be understood that the principles of this disclosure may be implemented in any number of other suitable devices, systems, or contexts.

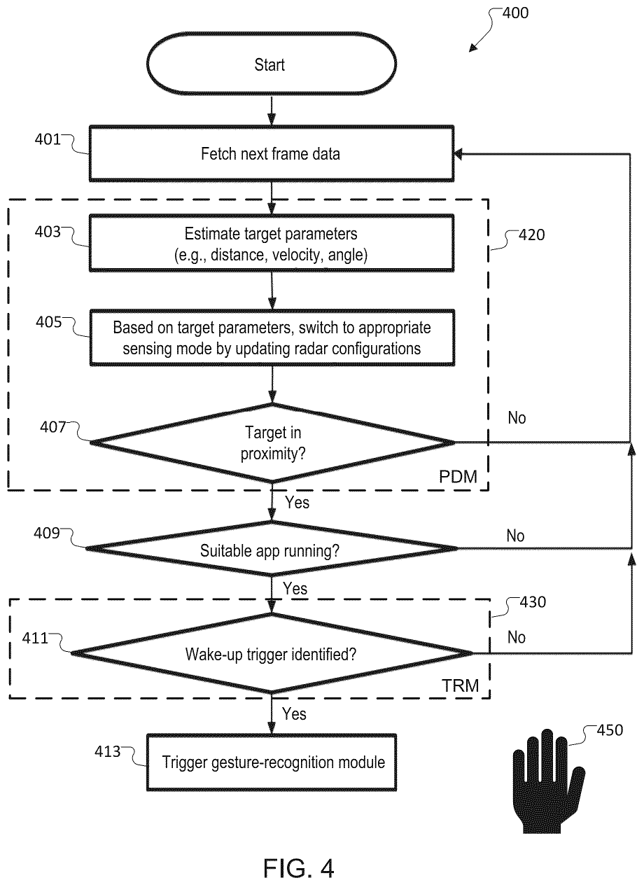

FIG. 4 illustrates an example process 400 for switching from proximity-sensing mode to the gesture-recognition mode according to embodiments of the present disclosure. For ease of explanation, the process 400 will be described as being performed using the electronic device 200 of FIG. 1; however, the process 400 could be performed by any other suitable device or system. The embodiment of the process 400 shown in FIG. 4 is for illustration only. Other embodiments of the process 400 could be used without departing from the scope of this disclosure.

As shown in FIG. 4, the process 400 includes a signal processing-based proximity detection module (PDM) 420 that detects the presence of a target 450 in the radar proximity, and a trigger recognition module (TRM) 430 that identifies a wake-up trigger for triggering the GRM. The objective is to estimate the target location using the radar capabilities of the electronic device 200. As used herein, the target 450 can be the fist, fingers, or another portion of the user. The radar of the electronic device 200 can be mmWave radar. As discussed below, the PDM 420 can perform a multi-stage proximity sensing operation, where depending on the target location, the PDM 420 progressively adjusts the configurations of the radar parameters from a lesser power consuming mode to a higher power consuming mode. This is based on the idea that when the target 450 is far away, the PDM 420 should operate in the least power-consuming mode that corresponds to the lowest configurations of the radar parameters. As the target 450 approaches the electronic device 200, the electronic device 200 needs better distance, angular, and velocity localization of the target 450. Hence, the electronic device 200 progressively switches to the stages that correspond to better estimation of target parameters at the cost of increased transmission and circuit power consumption for the radar. The radar configurations that need to be updated (e.g., increased or decreased) may include bandwidth of radar operation, number of pulses per frame, number of frames per second, number of active ADCs, ADC sampling rate, or the like. In this respect, the PDM 420 consumes less power that the GRM, which, as discussed above, typically includes multiple neural networks that can consume significant power to perform the necessary complex computations.

To avoid unnecessary triggers of the GRM, the process 400 includes two additional conditions that may need to be satisfied before triggering the GRM. The first condition is to check the status of the electronic device 200 on its readiness of accepting gesture-based commands. The objective is to allow gesture-based control of the electronic device 200 only when suitable applications are running in the background. The second condition is to enable the electronic device 200 to infer the user's intention of performing one or more gestures. In this case, the user should perform a wake-up trigger, which needs to be correctly identified by the electronic device 200 (while executing the TRM 430). This disclosure describes multiple gesture-based wake-up triggers that allow efficient rule-based identification of the trigger event. In addition, a complementary wake-up trigger mechanism based on a voice or acoustic-based command is described.

Initially, the electronic device 200 performs operation 401, in which next frame data is fetched. Here, it is assumed that the electronic device 200 is in the lowest proximity-sensing mode where the radar parameters (e.g., the number of pulses in a frame, the frame rate, the number of active ADCs, the ADC sampling rate, the transmission bandwidth, the transmission power, and the like) are set to the lowest defined configuration. For example, to save both transmission and circuit-related power consumption, the frame rate may be set to 10%-15% of the maximum frame rate. Hence, if the maximum frame rate is 30 frames per second (fps), then in the lowest proximity-sensing mode, the electronic device 200 can set the frame rate as 3 fps. Further, since a higher Doppler resolution is not necessary at this stage, a reduced number of pulses per frame may be transmitted, e.g., 30% of the maximum pulses per frame used in the gesture-recognition mode.

If the electronic device 200 is equipped with multiple receive antennas, then the electronic device 200 can use only one antenna for range estimation, as angle information of the target 450 may not be necessary in this stage. Hence, only one ADC corresponding to one of the receive antennas may be active. This helps in reducing the circuit power consumption. Further, reduction in the transmission bandwidth is also possible as finer resolutions for the target distance is not necessary at this stage. For example, while a 5 GHz bandwidth provides a range resolution of 3 cm, the electronic device 200 can operate at 30% of this bandwidth. Hence, the range resolution of the electronic device 200 becomes 10 cm. Assuming the target 450 is beyond 50 cm distance from the electronic device 200, the reduced range resolution is likely not to affect the proximity-sensing performance as the error in distance estimation is less than 20% (assuming perfect channel impulse response).

Depending on the location of the target 450, the electronic device 200 adjusts the configurations of the radar parameters by progressively switching to higher configurations. For example, consider an intermediate distance scenario where the target 450 is located at 30 cm. In this scenario, an intermediate value of the frame rate may be used. For example, the frame rate can be set to 70% of the maximum frame rate of 30 fps. For improved Doppler resolution, the number of pulses per frame should also be increased, e.g., 70% of the maximum pulses per frame. Further, the electronic device 200 may use 70% of the entire transmission bandwidth for improved resolution of the target distance. To facilitate tracking the angle of the target 450, multiple ADCs corresponding to multiple antennas may be used. This intermediate mode requires more operational power while providing better localization of the target parameters.

Herein, the proximity of the electronic device 200 can be defined as the region that is within 10 cm distance from the electronic device 200. If the user performs a gesture in the vicinity of this distance, the electronic device 200 should consider the gesture as a valid gesture. Hence, if the target 450 is at 15 cm, then the electronic device 200 should operate at the highest possible configuration defined by the gesture-recognition mode, since the target 450 may enter the proximity of the electronic device 200 within milliseconds. In such a scenario, the frame rate and pulse rate should be equal to the maximum frame rate of the gesture-recognition mode. Further, all the receive antenna ADCs should be active, since finer angular resolution may be necessary to determine that the target 450 is within the field-of-view of the radar. Also, the entire transmission bandwidth should be used for transmission.

Since proximity to the electronic device 200 is not a sufficient condition by itself to infer that the user intends to perform a gesture, the process 400 includes additional mechanisms to infer the user's intention. Further, for a better user experience, it may be desirable to allow gesture-based commands in a few specific scenarios such as controlling an audio player running in the background. Hence, checking the status of the electronic device 200 for its readiness to accept gesture inputs is also important. The additional mechanisms disclosed herein take both these factors into account before triggering the GRM. Once the electronic device 200 is in gesture-recognition mode, the electronic device 200 switches back to the proximity-sensing mode based on the mechanisms defined in GRM. That is, after the UE fetches frame data in operation 401, the electronic device 200 executes the PDM 420, which is responsible for estimating the target location, progressively reconfiguring the radar parameters based on target locations, and then inferring whether the target 450 is in the proximity or not.

To detect the presence of the target 450 in the proximity of the electronic device 200, the electronic device 200 performs operation 403, in which the PDM 420 estimates the following target parameters: (1) distance of the target 450, (2) velocity of the target 450, and (3) azimuth/elevation angle of the target 450. The guiding principle here is that as the user approaches the electronic device 200 to perform a gesture, the target 450 (i.e., the user's fingers or fist) should be within a specified distance and angle to the radar. Further, just before starting the micro-gesture, the target 450 should have significantly low or zero velocity. Hence, by comparing to a set of predefined thresholds corresponding to each of the parameters, the PDM 420 may declare that the target 450 is in the proximity.

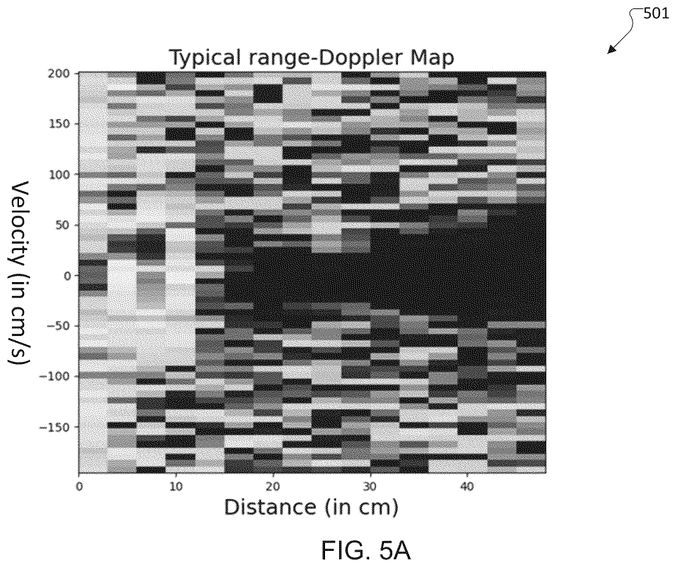

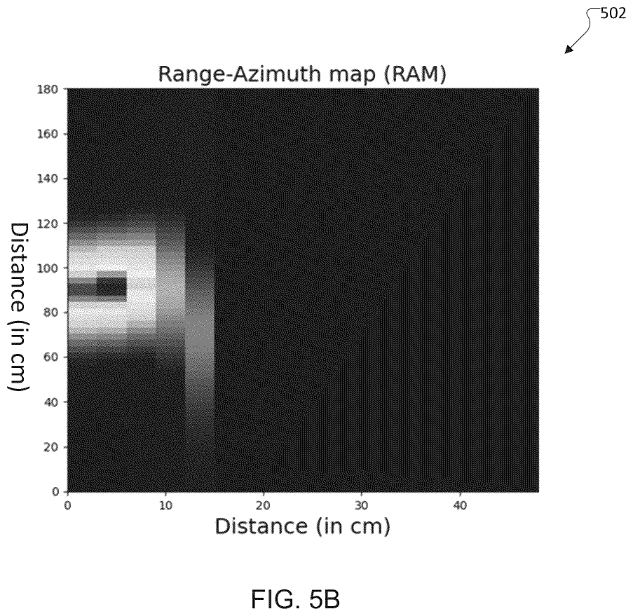

In some embodiments, to accurately estimate the three aforementioned target parameters, the electronic device 200 uses a range-Doppler map (RDM), a range-azimuth (angle) map (RAM), and a range-elevation (angle) map (REM). FIGS. 5A and 5B illustrate examples of a typical RDM 501 and a typical RAM 502, respectively. The RDM 501 captures movement in the radial direction and contains information regarding the distance and velocity of the target 450. The azimuth and the elevation angular information of the target 450 are embedded in the RAM 502 and REM, respectively. As shown in FIG. 5B, the RAM 502 reflects a spectrum that is obtained using a MUSIC algorithm. To estimate these quantities, 64 pulses in a frame are transmitted. Applying the appropriate spectrum estimation method, e.g., discrete Fourier transform, on the received data from one of the antennas, the RDM 501 can be obtained.

The electronic device 200 can use a two-dimensional (2D) peak finding method (or any other suitable technique) to estimate distance dₑₛₜ and velocity vₑₛₜ from the RDM 501. In a basic peak finding process, the electronic device 200 first obtains the maximum Doppler value for each distance bin, and then selects the maximum entity among these distance bins. For example, in FIG. 5A, dₑₛₜ≈7.5 cm and vₑₛₜ≈26.2 cm/s. Any other 2D peak finding process could also be used.

To estimate the RAM 502 and the REM, the electronic device 200 can use the data collected from multiple receiving antennas and apply an appropriate spectrum estimation method, such as Bartlett beamforming, Capon's beamforming, MUSIC, and the like. From the RAM 502 and the REM, the electronic device 200 obtains the azimuth angle θₑₛₜ and elevation angle ϕₑₛₜ of the target 450. In some embodiments, the electronic device 200 selects the column in the RAM 502 or REM that corresponds to dₑₛₜ and subsequently obtains the global peak through line search. For example, in FIG. 5B, there is a 1D peak found at dₑₛₜ≈10.5 cm, which corresponds to θₑₛₜ≈95 degrees. Note that angle estimation of the target 450 may not be necessary in the initial stages of the proximity-sensing when the target 450 is still far away.

Once the target parameters are estimated, the electronic device 200 performs operations 405 and 407 while executing the PDM 420. In operation 405, the electronic device 200 switches to the appropriate proximity-sensing mode by reconfiguring some of the radar parameters. As noted above, an objective of the multi-stage proximity-sensing is to save operational power by progressing from coarse to finer estimation of the target parameters depending on its distance, velocity, and angle. At operation 407, the electronic device 200 infers whether or not the target 450 is in the proximity of the electronic device 200.

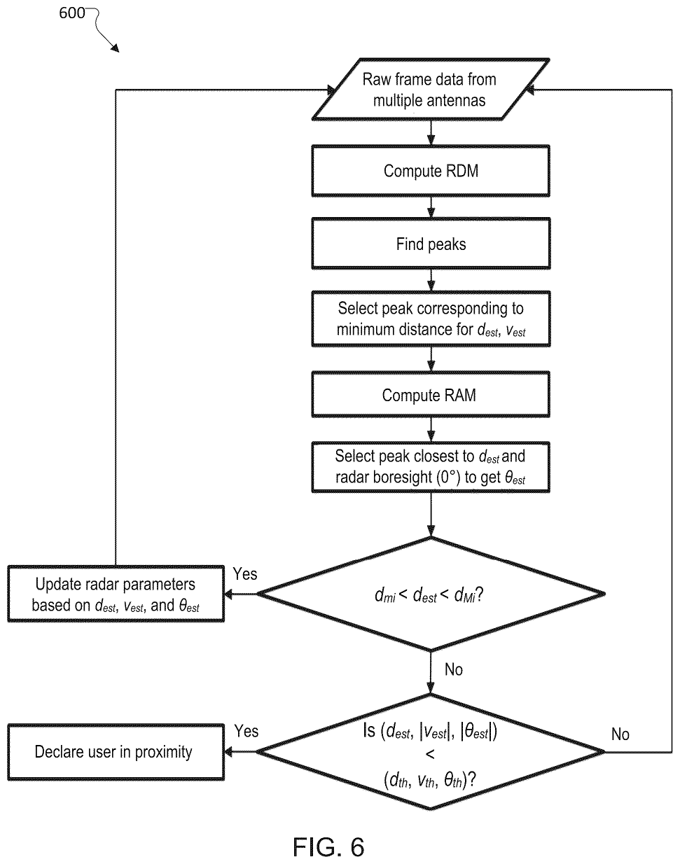

FIG. 6 illustrates a process 600 performed by the PDM 420 while executing in the electronic device 200 according to embodiments of the present disclosure. As shown in FIG. 6, the process 600 includes the sensing the target location, updating the radar configurations, and determining whether or not the target 450 is in proximity, which corresponds to operations 403, 405, and 407 of FIG. 4. The raw data from any of the receiving antennas may be used to obtain the RDM 501. To estimate the distance and the velocity of the target 450, the electronic device 200 uses the 2D peak finding method on the RDM 501, as shown in FIG. 5A. Assuming only one peak corresponds to the target, the electronic device 200 selects the first peak in the range domain and obtains the corresponding estimated distance dₑₛₜ and velocity vₑₛₜ. Next, using data from the appropriate set of antennas, the electronic device 200 computes the RAM 502. To estimate the angle corresponding to the target 450, the electronic device 200 selects the RAM column corresponding to dₑₛₜ. Then the electronic device 200 uses the 1D peak finding method to estimate the azimuth angle θₑₛₜ of the target 450, as shown in FIG. 5B. A similar process may be used to estimate elevation angle ϕₑₛₜ of the target 450 from the REM.

After estimating the target parameters, the electronic device 200 compares the parameters with respect to a predefined range of thresholds to switch to a specific proximity-sensing mode. The estimated distance is primarily used for switching to different proximity stages. The switching may also be performed using velocity and angle information. Further, as will be clearer from the following example scenarios, to update the bandwidth of operation, distance information may be used. The frame rate may be updated using the estimated target velocity. The number of pulses per frame may be updated using the distance and the velocity of the target. Further, the electronic device 200 may consider both distance and angle of the target 450 to update the number of ADCs.

For example, if 50 cm<dₑₛₜ, the electronic device 200 may set the transmission bandwidth to 30% of the total system bandwidth, since finer distance resolution is not necessary. If the system has a maximum 5 GHz bandwidth, then using 30% transmission bandwidth, a distance resolution of 10 cm is obtained. Further, an improved velocity resolution might not be needed at this stage. Hence, a reduced number of pulses per frame should be transmitted, e.g., 50% of the pulses per frame transmitted during the gesture-recognition mode. Further, at this distance, if the estimated velocity is more than 15 cm/s and less than 30 cm/s, then frequent updating of the target distance may not be necessary. Hence, the electronic device 200 can set the frame rate to 3 fps, which is approximately 10% of the maximum frame rate of 30 fps. At this frame rate, the maximum distance that the target can travel within two frames is vₑₛₜ/3≤10 cm. If the target velocity is more than 30 cm/s, the electronic device 200 may perform more frequent updates for the target distance. Hence, a higher frame rate may be used such that the target 450 does not move more than 10 cm between two frames. In some embodiments, it may not be necessary to track the angle of the target 450 at this range. Hence, the electronic device 200 may use only one ADC corresponding to one receive antenna.

In the next stage, when the target 450 is within 35 cm<dₑₛₜ≤50 cm and 15 cm/s<vₑₛₜ≤30 cm/s, the electronic device 200 can increase the transmission bandwidth to 60% of the maximum bandwidth so that the distance resolution improves to 5 cm. Further, the electronic device 200 can increase the frame rate to 6 fps so that the maximum distance that the target 450 may move within two frames is 5 cm. For a target 450 moving with a velocity greater than 30 cm/s, the electronic device 200 can adjust the frame rate (FR) such that vₑₛₜ/FR≤5 cm. At this distance, it may be necessary or preferable for the electronic device 200 to track the angle of the target 450. Hence, data from multiple receive antennas can be used. Since finer angular resolution still may not be necessary, using two receive antennas (subsequently, two ADCs) may be sufficient.

All these parameters may be appropriately adjusted when the target parameters are 15 cm<dₑₛₜ≤35 cm, 15 cm/s<vₑₛₜ≤30 cm/s, and −60°≤ϕₑₛₜ≤60°. At this stage, if the estimated target velocity is below 15 cm/s, then a finer velocity resolution might be necessary. This could be achieved by the electronic device 200 transmitting a higher number of pulses per frame compared to the previous two proximity-sensing modes. For example, the electronic device 200 may set the number of pulses to be 75% of the pulses transmitted during the gesture-recognition mode. Once the estimated distance of the target 450 is approximately 15 cm, the electronic device 200 can change the radar parameters to be the same as the parameters used in the gesture-recognition mode.

In the final stage, the electronic device 200 infers whether or not the target 450 is in the proximity of the electronic device 200. To do this, the electronic device 200 compare all three estimated parameters with respect to a corresponding set of thresholds. If all three estimated parameters satisfy the threshold criteria, then the electronic device 200 declares that the target is in the proximity. The thresholds may be selected based on the field of view of the radar and the fact that the velocity of the user's fist or finger should be low before the user starts performing the gesture. For example, assume a scenario where the gesture-based commands can be given at a distance of 10 cm or less from the electronic device 200. Further, the user needs to perform the gestures within ±30° of the radar boresight. In such a scenario, the electronic device 200 may set dₜₕ=12 cm and θₜₕ=±40°. The velocity threshold vₜₕ may be set to a small value such as 10 cm/s. The threshold values may change depending on the operational field of view of the radar and the distance at which the gesture need to be performed.

The presence of the target 450 in the proximity of the electronic device 200 does not necessarily mean that the user is about to perform a gesture or that the electronic device 200 is ready to accept the gesture-based commands. Hence, once the proximity detection is successful, additional conditions may be considered before triggering the gesture-recognition mode. These additional conditions for triggering the GRM will now be discussed.

Turning again to FIG. 4, at operation 409, the electronic device 200 determines whether or not a suitable application is running in the electronic device 200. While gesture-based commands provide additional flexibility in controlling the device and applications, such commands may degrade the user experience if not properly integrated with suitable applications. Hence, the gesture inputs may only be allowed when certain applications are running on the electronic device 200.

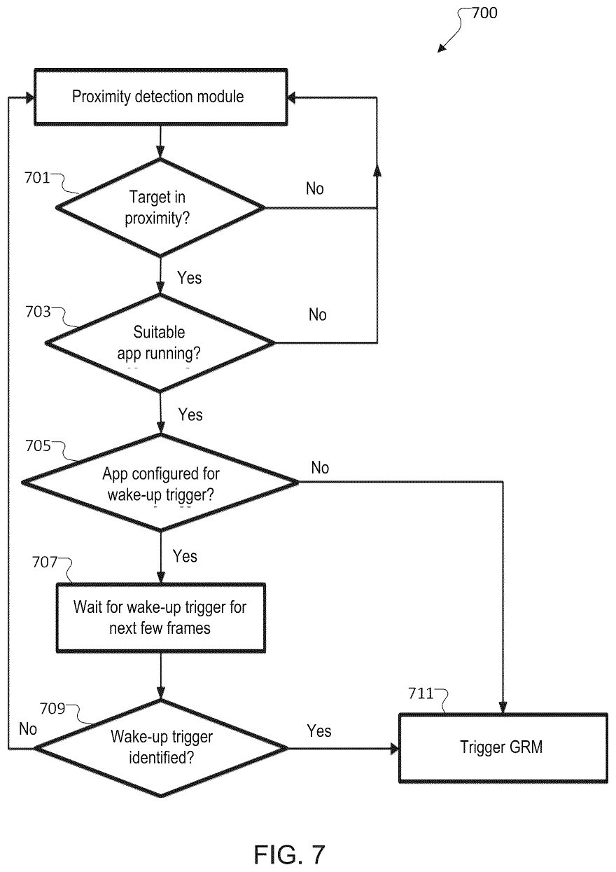

FIG. 7 illustrates a process 700 performed by the electronic device 200 for application driven triggering of the GRM, according to embodiments of the present disclosure. As shown in FIG. 7, the process 700 includes several operations that represent corresponding operations of the process 400. After the electronic device 200 has inferred (while executing the PDM 420) that the target 450 is in the proximity (operation 701), the electronic device 200 checks for suitable applications that are tuned for gesture-based commands (operation 703). If such an application is running on the electronic device 200, then the electronic device 200 can either wait for a wake-up trigger or directly trigger the GRM, depending on whether or not the application is configured for a wake-up trigger (operation 705). For example, in the case of pausing a media player, it may be desirable for the electronic device 200 to directly trigger the GRM. In contrast, if the user wants to resume playing a media, then it may be beneficial for the electronic device 200 to wait for a wake-up trigger by the user. The electronic device 200 tries to identify the wake-up trigger within a specified number of frames (operation 707). If a wake-up trigger is identified (operation 709 and operation 411 in FIG. 4), then the GRM is triggered (operation 711 and operation 413 in FIG. 4). Otherwise, the control goes back to the PDM 420. Overall, the process 700 reduces the false positives of triggering the GRM which improves the power efficiency.

Next, two types of wake-up triggers will be described. The first type is based on gestures and the second type is based on voice command. One objective of a gesture-based wake-up trigger is to make its signatures different from the signatures of the other gestures in the vocabulary. Further, the key signatures of a wake-up gesture should not be easily produced by accidental hand movements. Three such gesture-based wake-up triggers will now be described.

### Gesture-Based Wake-Up Trigger #1—Repetitive Micro-Gestures:

As previously discussed, the key signatures of any movement can be captured by the RDM 501, the RAM 502, and the REM. While the RDM 501 captures the movement of the target 450 in the radial direction, the movements in the azimuth and elevation angles are captured by the RAM 502 and the REM, respectively. To make the wake-up gesture signatures different from the signatures due to accidental hand motions, the movement can be periodic with certain orientation with respect to the radar so that the signatures are not easily producible by accidental motions. It is observed that a slanted inward-outward (i.e., radial) circular motion in front of the electronic device 200 is a good candidate for the wake-up gesture. The circular motion ensures that the distance, the azimuth angle, and the elevation angle of the target 450 approximately repeat themselves with the same period. Tracking this repetition for a few frames that is 10%-20% of the gesture window ensures the detection of the wake-up gesture with a low false positive probability. For example, if the gesture window is 50 frames, then the electronic device 200 should observe the common frequency for at least 5-10 frames before declaring a wake-up gesture has been performed.

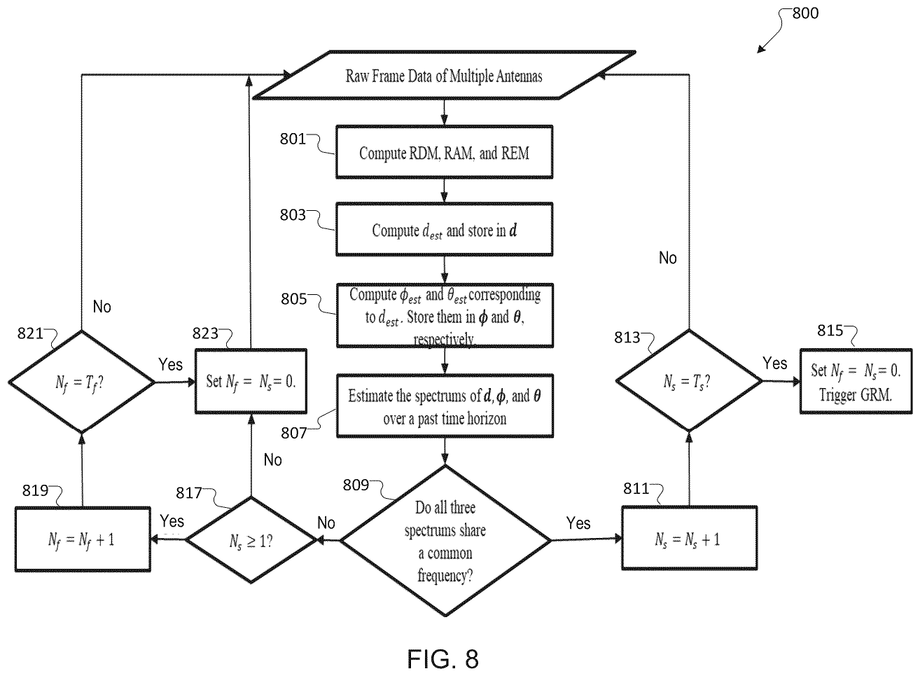

FIG. 8 illustrates a process 800 for triggering the GRM based on detection of the repetitive micro-gesture as the wake-up gesture, according to embodiments of the present disclosure. As shown in FIG. 8, the process 800 determines if multiple spectrums share a common frequency. As used herein, two spectrums share a common frequency when either of the first two peaks of one spectrum is within Δ_{ƒ} frequency apart from either of the first two peaks of the second spectrum. Using the raw frame data from all the antennas, the electronic device 200 computes the RDM, RAM, and REM (operation 801). From the RDM, the electronic device 200 estimates the distance of the target dₑₛₜ and stores it in an array d (operation 803). The dimension of d depends on the frame rate and the amount of past information to be stored. For example, if the frame rate is 24 fps and it is desired to store data corresponding to the last two seconds, then the dimension of d is 48. Further, using the azimuth and elevation RAMs, the electronic device 200 estimates the azimuth angle ϕₑₛₜ and elevation angle θₑₛₜ corresponding to dₑₛₜ (operation 805). Both these values are stored in arrays ϕ and θ, respectively, and their dimensions should be the same as d.

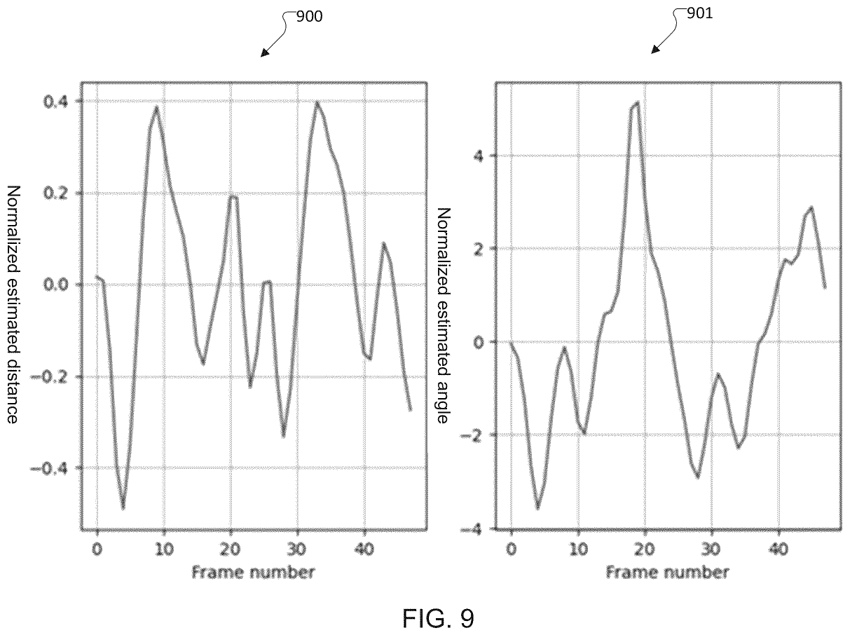

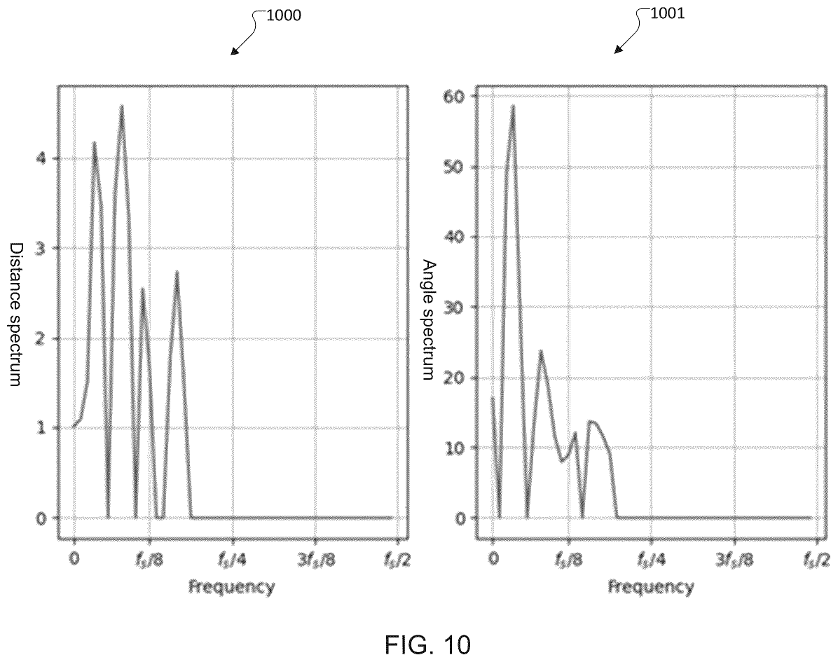

After acquisition of each frame, the electronic device 200 estimates the spectrums of d, ϕ, and θ using techniques such as Fourier transform, wavelet transform, or the like (operation 807). For example, FIG. 9 illustrates charts 900 and 901 showing a variation in the normalized distance and azimuth angle of the target 450 (e.g., a finger) for the repetitive micro-gesture. The variation is shown with respect to the frame number (a proxy for time). In FIG. 9, the total duration is approximately two seconds. In addition, FIG. 10 illustrates charts 1000 and 1001 showing the corresponding Fourier spectrums of the estimated distance and azimuth angle of the finger for the data presented in FIG. 9. The sampling frequency ƒₛ≈23 Hz. A common frequency in the spectrum can be observed at around ƒ=1.5 Hz that corresponds to 3 cycles over 48 frames (≈2 seconds). To identify the common frequency, the electronic device 200 first takes the discrete Fourier transforms for d, ϕ, and θ, respectively. Then the electronic device 200 determines the most prominent peak in each spectrum. For each spectrum, the electronic device 200 checks if the identified peak lies within a certain frequency window of the frequency bins corresponding to the peaks of the other two spectrums (operation 809). If the condition is met for all three spectrums, then the electronic device 200 declares that a common frequency has been identified, and increments the number of successful frames Nₛ (operation 811).

To explain in greater detail, assume that one period of the wake-up gesture is N_{wg} frames. Once a common frequency in the spectrums of d, ϕ, and θ has been identified, to reduce the probability of false positives, the electronic device 200 repeat the process of identifying the common frequency component for a few more frames. Once the number of successful frames Nₛ (i.e., frames where a common frequency component has been identified) reaches a threshold Tₛ (<N_{wg}) (operation 813), the electronic device 200 triggers the GRM (operation 815). At the same time, the electronic device 200 also resets the counters Nₛ and N_{ƒ} that count the number of successful and unsuccessful frames where a common frequency is present in the spectrums, respectively. The electronic device 200 also resets the counters Nₛ and N_{ƒ} after the event when the electronic device 200 has identified T_{ƒ} (<N_{wg}) frames where there are no common frequency components in the spectrums of d, ϕ, and θ (operations 817 through 823). As explained earlier, the operations here should be carried out within a specified number of frames once the electronic device 200 waits for a valid wake-up gesture. In some embodiments, it is important that the number of frames the electronic device 200 needs to wait should be larger than N_{w} . If the electronic device 200 is unable to identify a wake-up gesture for Tₛ successful frames within these specified number of frames, the control goes back to the PDM 420.

Gesture-Based Wake-Up Trigger #2—Palm Facing the Radar:

Here, the RAM 502 and the REM are used to implement this wake-up gesture. In this gesture, the user puts the palm in front of the electronic device 200 within a specified distance. Once the frame data is captured from multiple receiving antennas, the electronic device 200 estimates the two dimensional power-angle spectrum (PAS) using a suitable method such as Fourier transform. Since the palm is assumed to be static for this gesture, the electronic device 200 does not invoke the sequence of logics unless there are only low velocity components (e.g., less than 1 cm/s) in the RDM 501 corresponding to the range bin where the palm is placed in front of the radar.

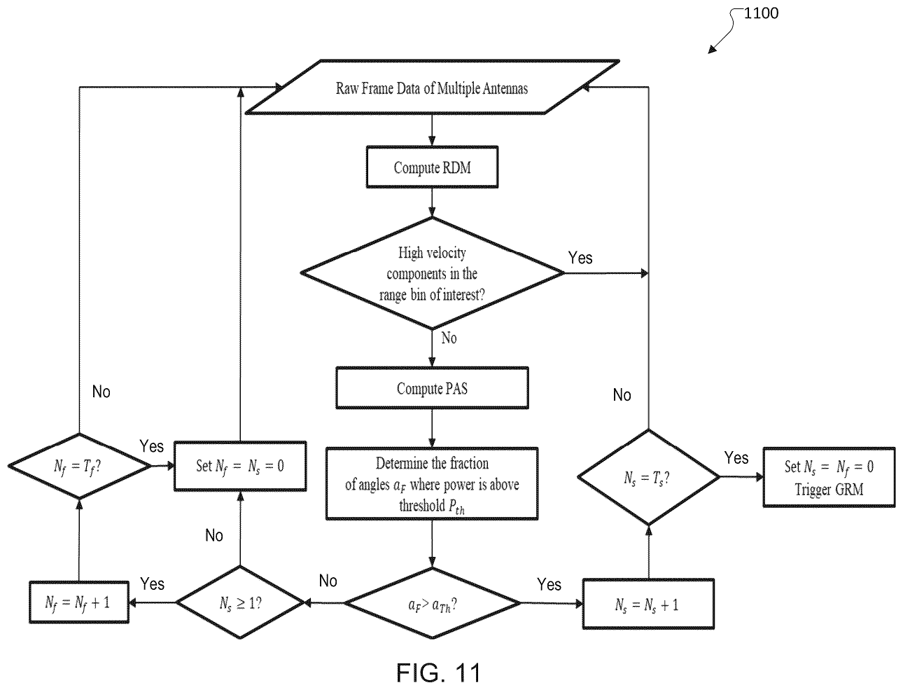

FIG. 11 illustrates an example process 1300 for triggering the GRM using this wake-up gesture according to embodiments of the present disclosure. As shown in FIG. 11, once the electronic device 200 determines that the palm is steady in front of the electronic device 200 by the average speed check, the electronic device 200 determines the fraction of angles a_{F} on which the power is more than a predefined power threshold Pₜₕ. If this fraction of angles a_{F} is more than a predefined threshold a_{Th}, then the electronic device 200 declares that the wake-up gesture has been detected successfully and increments the counter Nₛ of the number of successful frames. In contrast, if the fraction of angle is less than this threshold, then the electronic device 200 increments N_{ƒ} that keeps the count of the number of frames where the detection is a failure. Once the electronic device 200 is able to identify at least Tₛ frames where the wake-up gesture has been detected successfully, the GRM is triggered. As discussed above (in conjunction with FIG. 7), the electronic device 200 performs these operations within a specified number of frames while the electronic device 200 waits for a valid wake-up gesture. In some embodiments, it is important that the number of frames the electronic device 200 waits should be certain multiples of Tₛ. If the electronic device 200 is unable to identify a wake-up gesture for Tₛ successful frames within these specified number of frames, the control goes back to the PDM 420.

Gesture-Based Wake-Up Trigger #3—Micro-Movement of Multiple (e.g., four) Fingers:

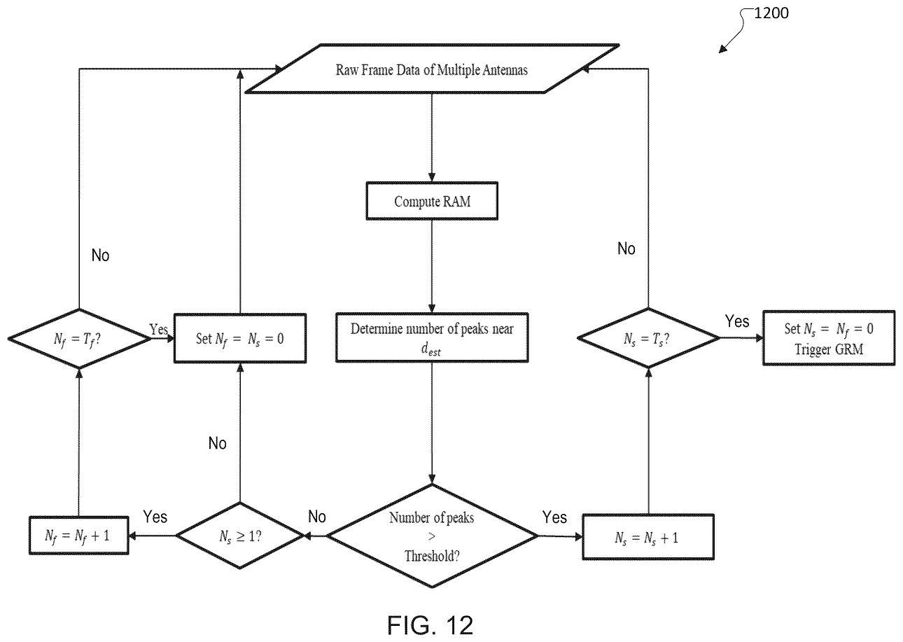

This wake-up gesture is more useful when the gestures in the vocabulary are designed to be performed with one or two fingers. This gesture is based on the principle that the movement of four fingers will lead to a greater number of peaks in the RAM 502 compared to the typical RAM of a gesture. FIG. 12 illustrates an example process 1200 for triggering the GRM using this wake-up gesture according to embodiments of the present disclosure. The presence of multiple receiving antennas (e.g., more than four) is assumed at the radar of the electronic device 200. First, using the data from all the antennas, the electronic device 200 computes the RAM 502. Next, the electronic device 200 determines the number of peaks that are close to the line at (x=dₑₛₜ), where x represent the range-axis in the RAM 502. If the number of peaks is more than a predefined threshold, then the electronic device 200 increases Nₛ, which is the counter for the number of frames in which multiple finger movements are registered successfully. Once the number of frames in which multiple peaks are determined successfully reaches Tₛ, then GRM is triggered. To avoid accidental triggers of GRM, the process 1200 also includes a counter N_{ƒ} that keeps track of the number of unsuccessful frames in which the number of peaks is less than the threshold. After a few successful detections, if the electronic device 200 encounters T_{ƒ} unsuccessful frames, then the electronic device 200 resets Nₛ. As mentioned before, the electronic device 200 performs these operations within a specified number of frames once the electronic device 200 waits for a valid wake-up gesture. In some embodiments, it is important that the number of frames the electronic device 200 waits should be certain multiples of Tₛ. If the electronic device 200 is unable to identify a wake-up gesture for Tₛ successful frames within these specified number of frames, the control goes back to the PDM 420.

### Voice-Based GRM Trigger

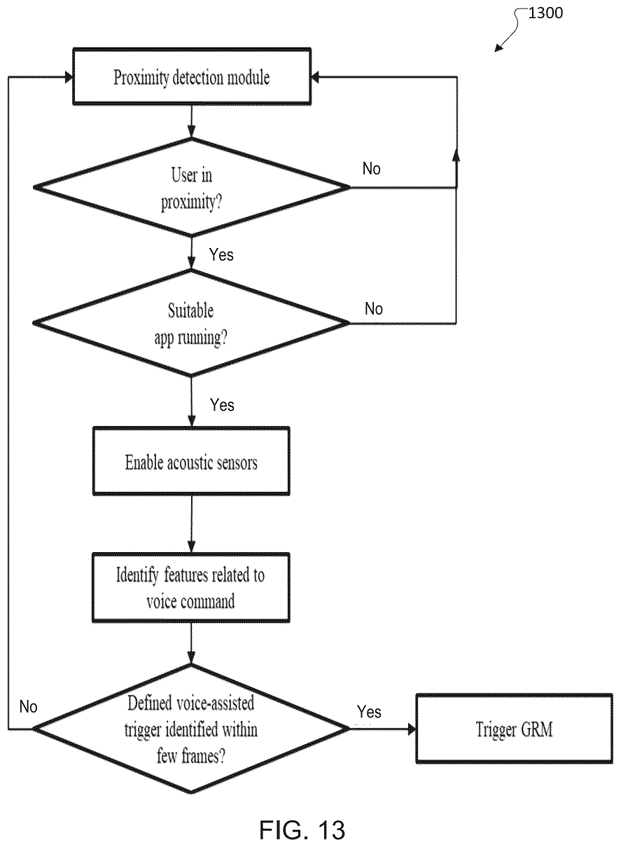

The previously described three triggers are gesture-based wake-up triggers. Another approach is a wake-up trigger using one or more voice commands. This type of wake-up trigger may be suitable for environments where frequent or continuous interaction with the electronic device 200 is expected (e.g., scrolling a web page using gestures). If the target 450 is in the proximity of the electronic device 200, then a voice-based wake-up command may be directly used to trigger the GRM. Since the probability of false positives in a voice-based trigger is likely to be less, it may be preferred over the gesture-based triggers in case both types of triggers are performed simultaneously. FIG. 13 illustrates an example process 1300 for triggering the GRM using a voice-assisted wake-up trigger according to embodiments of the present disclosure. Once the user is in the proximity and a suitable application that is configured to accept gesture-based command is running in the electronic device 200, the acoustic sensors of the electronic device 200 are activated to identify any possible voice-assisted trigger for the GRM. If the voice command is not identified within a few specified frames, then the electronic device 200 returns to proximity-sensing mode. In some embodiments, the number of frames for which the electronic device 200 should wait to identify the voice-assisted wake-up trigger could be a number of frames that correspond to about 1-2 seconds.

Although FIGS. 4 through 13 illustrate an example of a process 400 for switching from proximity-sensing mode to the gesture-recognition mode and related details, various changes may be made to FIGS. 4 through 13. For example, various components in FIGS. 4 through 13 could be combined, further subdivided, or omitted and additional components could be added according to particular needs. In addition, various operations in FIGS. 4 through 13 could overlap, occur in parallel, occur in a different order, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
during operation of a proximity-detection module of an electronic device:
determining a distance, velocity, and angle of a target relative to the electronic device based on radar data obtained from a radar transceiver of the electronic device;
adjusting a configuration of the radar transceiver based on at least one of the distance, velocity, or angle of the target; and
while at least one of the distance, velocity, or angle is greater than a respective threshold, repeating the determining and adjusting operations;
in response to determining that each of the distance, velocity, and angle is less than its respective threshold, determining whether at least one wake-up trigger for gesture-based commands is detected; and
in response to determining that the at least one wake-up trigger for gesture-based commands is detected, triggering operation of a gesture-recognition module of the electronic device.

2. The method of claim 1, wherein the wake-up trigger comprises at least one of:
a repetitive micro-gesture performed by a user;
a palm of the user facing the electronic device;
a micro-movement of multiple fingers of the user; and
a voice-based wake-up command.

3. The method of claim 1, wherein the target comprises a finger or a hand of a user.

4. The method of claim 1, wherein:
the gesture-recognition module comprises multiple neural networks; and
the proximity-detection module consumes less power than the gesture-recognition module.

5. The method of claim 1, wherein adjusting the configuration of the radar transceiver based on at least one of the distance, velocity, or angle of the target comprises:
increasing or decreasing at least one of a radar bandwidth, a number of pulses per frame, a number of frames per second, a number of active analog-to-digital converters (ADCs), or an ADC sampling rate when the distance of the target from the electronic device becomes less than each of multiple distance thresholds as the target moves toward the electronic device.

6. The method of claim 1, wherein determining the distance, velocity, and angle of the target relative to the electronic device comprises:
using a range-Doppler map by the proximity-detection module to estimate the distance and the velocity of the target, and
using a range-azimuth map by the proximity-detection module to estimate the angle of the target.

7. The method of claim 1, further comprising:
in response to determining that the distance of the target is less than a distance threshold, determining whether an application configured for a wake-up trigger is currently running on the electronic device.

8. A device comprising:
a radar transceiver; and
a processor operably connected to the radar transceiver, the processor configured to:
during operation of a proximity-detection module:
determine a distance, velocity, and angle of a target relative to the device based on radar data obtained from the radar transceiver;
adjust a configuration of the radar transceiver based on at least one of the distance, velocity, or angle of the target; and
while at least one of the distance, velocity, or angle is greater than a respective threshold, repeat the determine and adjust operations;
in response to determining that each of the distance, velocity, and angle is less than its respective threshold, determine whether at least one wake-up trigger for gesture-based commands is detected; and
in response to determining that the at least one wake-up trigger for gesture-based commands is detected, trigger operation of a gesture-recognition module.

9. The device of claim 8, wherein the wake-up trigger comprises at least one of:
a repetitive micro-gesture performed by a user;
a palm of the user facing the device;
a micro-movement of multiple fingers of the user; and
a voice-based wake-up command.

10. The device of claim 8, wherein the target comprises a finger or a hand of a user.

11. The device of claim 8, wherein:
the gesture-recognition module comprises multiple neural networks; and
the proximity-detection module consumes less power than the gesture-recognition module.

12. The device of claim 8, wherein to adjust the configuration of the radar transceiver based on at least one of the distance, velocity, or angle of the target, the processor is configured to:
increase or decrease at least one of a radar bandwidth, a number of pulses per frame, a number of frames per second, a number of active analog-to-digital converters (ADCs), or an ADC sampling rate when the distance of the target from the device becomes less than each of multiple distance thresholds as the target moves toward the device.

13. The device of claim 8, wherein to determine the distance, velocity, and angle of the target relative to the device, the processor is configured to:
using a range-Doppler map by the proximity-detection module to estimate the distance and the velocity of the target, and
using a range-azimuth map by the proximity-detection module to estimate the angle of the target.

14. The device of claim 8, wherein the processor is further configured to:
in response to determining that the distance of the target is less than a distance threshold, determine whether an application configured for a wake-up trigger is currently running on the device.

15. A non-transitory computer readable medium comprising program code that, when executed by a processor of a device, causes the device to:
during operation of a proximity-detection module:
determine a distance, velocity, and angle of a target relative to the device based on radar data obtained from a radar transceiver of the device;
adjust a configuration of the radar transceiver based on at least one of the distance, velocity, or angle of the target; and
while at least one of the distance, velocity, or angle is greater than a respective threshold, repeating the determine and adjust operations;
in response to determining that each of the distance, velocity, and angle is less than its respective threshold, determine whether at least one wake-up trigger for gesture-based commands is detected; and
in response to determining that the at least one wake-up trigger for gesture-based commands is detected, trigger operation of a gesture-recognition module of the device.

16. The non-transitory computer readable medium of claim 15, wherein the wake-up trigger comprises at least one of:
a repetitive micro-gesture performed by a user;
a palm of the user facing the device;
a micro-movement of multiple fingers of the user; and
a voice-based wake-up command.

17. The non-transitory computer readable medium of claim 15, wherein the target comprises a finger or a hand of a user.

18. The non-transitory computer readable medium of claim 15, wherein:
the gesture-recognition module comprises multiple neural networks; and
the proximity-detection module consumes less power than the gesture-recognition module.

19. The non-transitory computer readable medium of claim 15, wherein the program code that causes the device to adjust the configuration of the radar transceiver based on at least one of the distance, velocity, or angle of the target comprises program code to:
increase or decrease at least one of a radar bandwidth, a number of pulses per frame, a number of frames per second, a number of active analog-to-digital converters (ADCs), or an ADC sampling rate when the distance of the target from the device becomes less than each of multiple distance thresholds as the target moves toward the device.

20. The non-transitory computer readable medium of claim 15, wherein the program code that causes the device to determine the distance, velocity, and angle of the target relative to the device comprises program code to:
use a range-Doppler map by the proximity-detection module to estimate the distance and the velocity of the target, and
use a range-azimuth map by the proximity-detection module to estimate the angle of the target.
